(19) United States
(12) Patent Application Publication
(10) Pub. No.: US 2024/0236233 A9
(43) Pub. Date: Jul. 11, 2024

(54) CALL ALERT DEVICE, CALL ALERT METHOD, AND CALL ALERT PROGRAM

(71) Applicant: Nippon Telegraph and Telephone Corporation, Tokyo (JP)

(72) Inventors: Naoyuki IIJIMA, Musashino-shi, Tokyo (JP); Hiroshi SHIMIZU, Musashino-shi, Tokyo (JP)

(21) Appl. No.: 18/277,490

(22) PCT Filed: Feb. 17, 2021
(86) PCT No.: PCT/JP2021/005834

§ 371 Date: Aug. 16, 2023

(51) Int. Cl. H04M 3/436; G10L 15/08; H04M 1/663

(52) U.S. Cl. CPC H04M 3/436; G10L 15/08; H04M 1/663; G10L 2015/088

(57) ABSTRACT

An SIP server (21) of a receiving side service provider (21D) includes an SIP reception unit (52) that receives a call signal originated in a calling side terminal (11) for a receiving side terminal (31) as a transmission destination, an SIP processing unit (54) that determines that a warning signal is necessary in a case where a combination of a number conversion history of the call signal set by an SIP server (22) that has transferred the call signal by a transfer service involving number conversion and calling side information of the calling side terminal (11) set in the call signal meets a specific condition, and a call processing unit (53) that transmits the warning signal to the receiving side terminal (31) before transmitting the call signal to the receiving side terminal (31) according to the determination of the SIP processing unit (54).

### TECHNICAL FIELD

The present invention relates to a call warning device, a call warning method, and a call warning program.

### BACKGROUND ART

In recent years, while the number of cases of special fraud has increased greatly, telephone calls of “it's me” scam (impersonation fraud telling “I'm your son”) account for more than half of the cases, and thus measures against fraud using telephone calls are required. In addition, with the spread of IP networks, a call signal of special fraud may flow into the network as a session initiation protocol (SIP) signal.

Patent Literature 1 describes a method of providing guidance to a call receiving user before an end-to-end media connection between a calling terminal and a call receiving terminal in a communication system that performs call control by SIP. Thus, the call receiving person can determine whether or not to connect by performing an operation required by the guidance or the like.

Patent Literature 2 describes a call system in which evaluation information (such as whether it is written on a blacklist) of the calling terminal is provided to the call receiving terminal before the call receiving terminal responds to a call from the calling terminal, and then the call receiving terminal engages in a call with the calling terminal. Thus, the call receiving terminal can appropriately select a scene to answer a call, such as rejecting a call from a calling terminal with poor evaluation and answering a call from a calling terminal with good evaluation, and can reject the call according to an instruction of the call receiving person.

### CITATION LIST

### Patent Literature

Patent Literature 1: JP 2012-165285 A
Patent Literature 2: JP 2016-163303 A

### SUMMARY OF INVENTION

### Technical Problem

In a method of registering an attacker in the blacklist in the conventional technology, registration or the like of calling numbers used for special fraud in advance is necessary. Therefore, if the attacker frequently changes the calling number, the blacklist becomes obsolete, and the measures against special fraud may not be sufficiently taken.

Further, in order to delay identification (tracking) that the attacker himself/herself is a caller of the special fraud, the attacker may use a method of passing through a plurality of service providers or a method of passing through a foreign service provider.

FIG. 8 is a configuration diagram in a case where the method of passing through a plurality of service providers is applied.

An example of a case where a call made from a calling side terminal 11z reaches a call receiving number “0422-88-8888” of a receiving side terminal 31z via four SIP servers (SIP server 24z→SIP server 23z→SIP server 22z→SIP server 21z) will be described.

A calling side service provider 24Dz manages the SIP server 24z that accommodates the calling side terminal 11z.

A connection service provider 23Dz manages the SIP server 23z in which a call receiving number [03-1111-2222] for transfer is set.

A connection service provider 22Dz manages the SIP server 22z in which a call receiving number [03-1111-3333] for transfer is set.

A receiving side service provider 21Dz manages the SIP server 21z accommodating the receiving side terminal 31z.

In such a transfer service, since the call receiving number of the call signal is switched from the number of the transfer source to the number of a transfer destination, it is difficult to identify the special fraud.

FIG. 9 is a configuration diagram in a case where the method of passing through a foreign service provider is applied.

A case where a call made from a foreign calling side terminal 11z reaches a domestic receiving side terminal 31z via three SIP servers (SIP server 23z→SIP server 22z→SIP server 21z) will be exemplified.

The connection service provider 23Dz manages the SIP server 23z that accommodates the calling side terminal 11z.

The connection service provider 22Dz manages the SIP server 22z that relays a call across two countries.

The receiving side service provider 21Dz manages the SIP server 21z accommodating the receiving side terminal 31z.

With respect to the methods for laundering (hiding) information of the caller as described in FIGS. 8 and 9, it is necessary to follow another clue indicating a call tendency of the special fraud that is not used in the conventional techniques such as Patent Literatures 1 and 2. That is, there is a need for flexibility in special fraud detection that does not rely on fixed caller information such as blacklists.

Accordingly, a main object of the present invention is to appropriately issue a warning even if information of a caller of special fraud is hidden.

### Solution to Problem

In order to solve the above problem, a call warning device of the present invention has the following characteristics.

The present invention includes:
a call signal reception unit that receives a call signal originated in a calling side terminal for a receiving side terminal as a transmission destination;
a call signal processing unit that determines that a warning signal is necessary in a case where a combination of a number conversion history of the call signal set by a connection device that has transferred the call signal by a transfer service involving number conversion and calling side information of the calling side terminal set in the call signal meets a specific condition; and
a warning processing unit that transmits the warning signal to the receiving side terminal before transmitting the call signal to the receiving side terminal according to the determination of the call signal processing unit.

### Advantageous Effects of Invention

According to the present invention, even if information of a caller of a special fraud is hidden, a warning can be appropriately issued.

### BRIEF DESCRIPTION OF DRAWINGS

FIG. 1 is a configuration diagram of a call warning system for determining necessity of warning by a combination of a number conversion history and calling side information according to the present embodiment.

FIG. 2 is a configuration diagram of an SIP server according to the present embodiment.

FIG. 3 is a hardware configuration diagram according to the present embodiment.

FIG. 4 is a flowchart illustrating details of warning necessity determination processing executed by the SIP server according to the present embodiment.

FIG. 5 is a configuration diagram in a case where a call according to the present embodiment passes through a foreign service provider.

FIG. 6 is a configuration diagram in a case where a call according to the present embodiment passes through a plurality of service providers.

FIG. 7 is a configuration diagram in a case where an excessive warning according to the present embodiment is suppressed.

FIG. 8 is a configuration diagram in a case where a method via a plurality of service providers is applied.

FIG. 9 is a configuration diagram in a case where a method passing through a foreign service provider is applied.

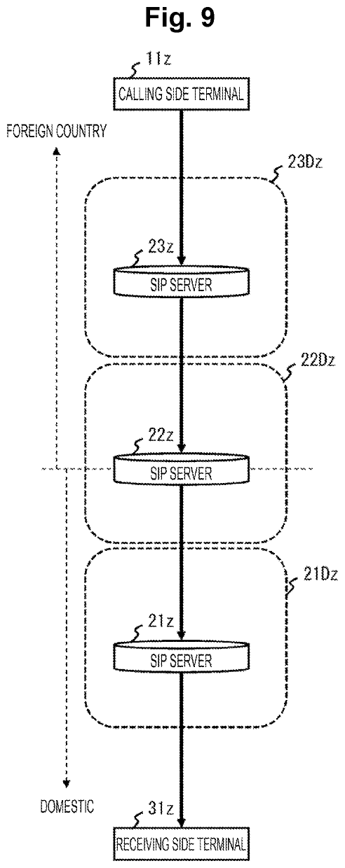

### DESCRIPTION OF EMBODIMENTS

Hereinafter, an embodiment of the present invention will be described in detail with reference to the drawings.

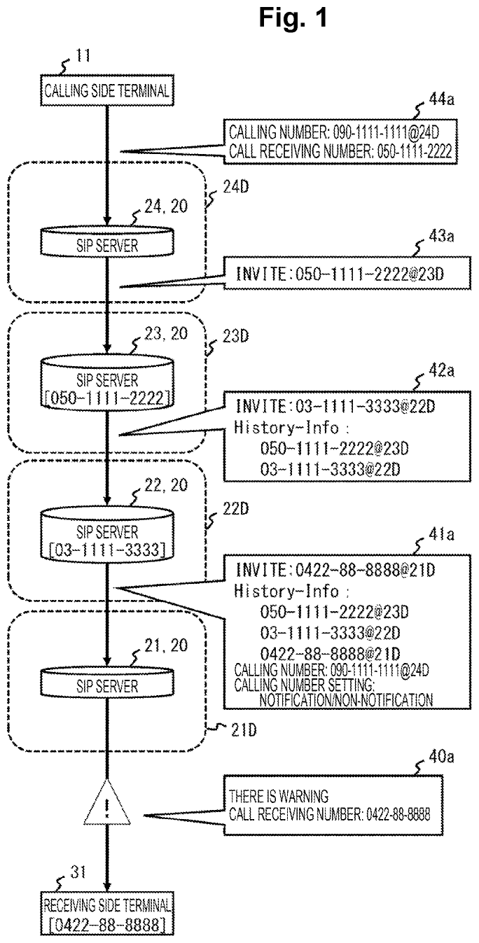

FIG. 1 is a configuration diagram of a call warning system that determines necessity of a warning by a combination of a number conversion history and calling side information.

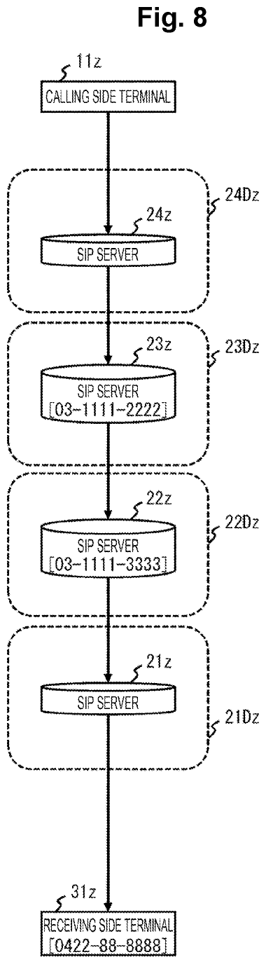

As in FIG. 8, a case where a call made from a calling side terminal 11 arrives at a call receiving number “0422-88-8888” of a receiving side terminal 31 via four SIP servers 20 (SIP server 24→SIP server 23→SIP server 22→SIP server 21) will be exemplified.

A calling side service provider 24D manages the SIP server 24 accommodating the calling side terminal 11.

A connection service provider 23D manages the SIP server 23 in which a call receiving number [050-1111-2222] for transfer is set.

A connection service provider 22D manages the SIP server 22 in which a call receiving number [03-1111-3333] for transfer is set.

A receiving side service provider 21D manages the SIP server 21 accommodating the receiving side terminal 31.

As terms in the present specification, “transfer” and “relay” are used separately. For example, it is assumed that an SIP signal (call signal) pass through the first SIP server 20→the second SIP server 20→the third SIP server 20 in this order. Here, when the second SIP server 20 changes the call receiving number (destination) of the SIP signal, “transfer” is set, and when the call receiving number is not changed, “relay” is set. For example, FIG. 1 illustrates the following.
The SIP server 24 relays a received call signal 44a as an SIP signal 43a.
The SIP server 23 (connection device) transfers the received SIP signal 43a as an SIP signal 42a.
The SIP server 22 (connection device) transfers the received SIP signal 42a as an SIP signal 41a.
The SIP server 21 (call warning device) relays (calls) the received SIP signal 41a as a call signal 40a.

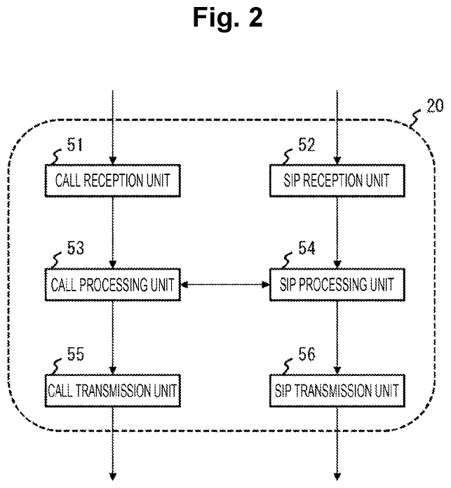

Note that details of the call signals 40a and 44a and the SIP signals 41a to 43a will be clarified in the description of FIG. 2.

Then, in a case where the SIP signal is transferred, each SIP server 20 sets the number of the transfer source and the number of the transfer destination in a number conversion history (History-Info) of the received SIP signal, and then transmits the SIP signal to the transfer destination. Note that each SIP server 20 may register the SIP server 20 of another device in the Privacy header of the SIP signal (not illustrated) as a device that permits notification of the content notification of History-Info (that is, a trusted device).

Here, since the transfer service tends to be abused in the “it's me” scam, when the content of the number conversion history of the SIP signal 41a that has arrived at the SIP server 21 is unnatural, the SIP server 21 sends out guidance (warning signal) for warning before starting a call of the call signal 40a to the receiving side terminal 31.

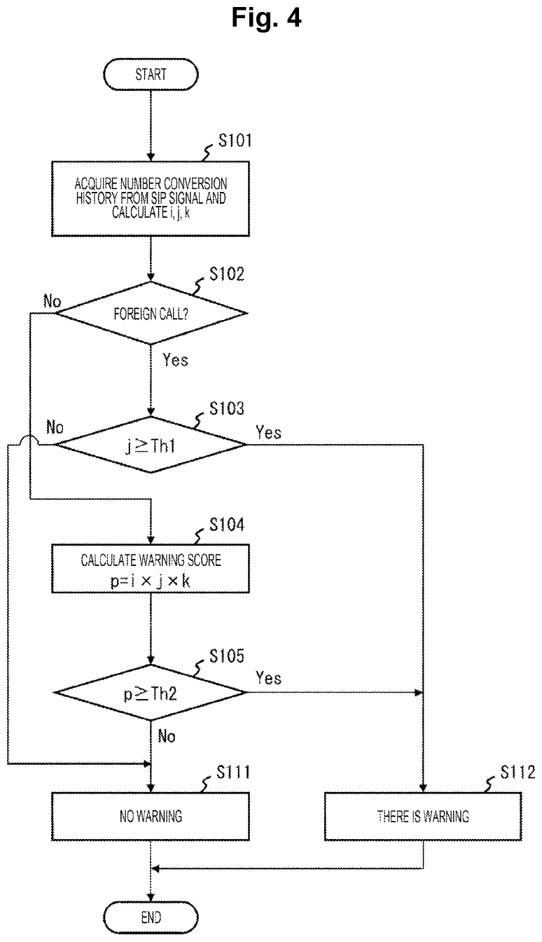

Note that, since the number conversion history is information distributed among the service providers, the number conversion history is information that cannot be deleted by an attacker from the outside of the service provider for the purpose of hiding evidence. Details of the determination processing as to whether or not to send the warning on the basis of the content of the number conversion history will be described later with reference to a flowchart of FIG. 4. Further, a specific SIP procedure for sending out guidance before starting a call is described in Patent Literature 1.

FIG. 2 is a configuration diagram of the SIP server 20.

The SIP server 20 includes a call reception unit 51, an SIP reception unit (call signal reception unit) 52, a call processing unit (warning processing unit) 53, an SIP processing unit (call signal processing unit) 54, a call transmission unit 55, and an SIP transmission unit 56. Hereinafter, processes of the SIP server 20 will be described along the contents of respective signals (call signals 40a, 44a and SIP signals 41a to 43a) in FIG. 1.

First, the SIP server 24 of the calling side service provider 24D will be described.

The call reception unit 51 of the SIP server 24 receives the call signal 44a from the calling side terminal 11. The call signal 44a includes a calling number “090-1111-1111” of the calling side terminal 11 and the call receiving number “050-1111-2222” of the transfer service provided by the SIP server 23.

Note that “@24D” after the calling number “090-1111-1111” is an ID of the calling side service provider 24D specified from a number band of the calling number “090-1111-1111”. Hereinafter, the reference sign “24D” of the calling side service provider 24D is described after the @ mark, thereby indicating the ID of the service provider specified from the telephone number.

Here, a service provider is assigned to a calling number type (0AJ/0A0) in each number band by an administrative agency. For example, “0AJ” indicates an area code (for example, A=4 and J=2) of a fixed-line phone. “0A0” indicates a mobile number (A=8, 9), a PHS number (A=7), and an IP telephone (A=5).

Thus, from the combination of the calling number type and the service provider domain, the SIP server 20 can specify that each received signal has passed through a predetermined service provider. Further, the call processing unit 53 recognizes that the call is addressed to another service provider (connection service provider 23D) from the call receiving number of the received call signal 44a. The SIP processing unit 54 creates the SIP signal 43a including the call receiving number of the call signal 44a as INVITE. The SIP transmission unit 56 transmits the created SIP signal 43a to the SIP server 23.

Next, the SIP server 23 of the connection service provider 23D will be described.

The SIP reception unit 52 of the SIP server 23 receives the SIP signal 43a from the SIP server 24. The SIP processing unit 54 acquires the new call receiving number “03-1111-3333” of the SIP server 22 as the transfer destination from setting data of the transfer service according to the call receiving number “050-1111-2222” of the received SIP signal 43a.

The SIP processing unit 54 creates the SIP signal 42a from the SIP signal 43a by the following processing.
The call receiving number (INVITE) is replaced from “050-1111-2222” of the transfer source to “03-1111-3333” of the transfer destination.
A History-Info header is newly created, and “050-1111-2222” of the transfer source and “03-1111-3333” of the transfer destination are added to the History-Info header.

The SIP transmission unit 56 transfers the created SIP signal 42a to the SIP server 22.

Then, the SIP server 22 of the connection service provider 22D will be described.

The SIP reception unit 52 of the SIP server 22 receives the SIP signal 42a from the SIP server 23. The SIP processing unit 54 acquires the new call receiving number “0422-88-8888” of the receiving side terminal 31 as a transfer destination from the setting data of the transfer service according to the call receiving number “03-1111-3333” of the received SIP signal 42a.

When the SIP signal 42a is created from the SIP signal 41a, the SIP processing unit 54 replaces the call receiving number (INVITE) from “03-1111-3333” of the transfer source with “0422-88-8888” of the transfer destination, and adds “0422-88-8888” of the transfer destination to the History-Info header.

Furthermore, the SIP processing unit 54 adds “calling number: 090-1111-1111@24D” and “calling number setting: notification/non-notification” to the SIP signal 41a as setting information of the calling side terminal 11. The “calling number setting: notification/non-notification” is a setting as to whether or not to notify of the calling number. The setting information of the calling side terminal 11 is included not only in the SIP signal 41a but also in the SIP signal 42a and the SIP signal 43a (not illustrated).

The SIP transmission unit 56 transmits the created SIP signal 41a to the SIP server 21 directed to the receiving side terminal 31 of the transfer destination.

Then, the SIP server 21 will be described.

The SIP reception unit 52 of the SIP server 21 receives the SIP signal 41a from the SIP server 22. The SIP processing unit 54 recognizes that the call receiving number of the received SIP signal 41a is the receiving side terminal 31 in which it is accommodated.

Here, by executing the determination processing of FIG. 4, the SIP processing unit 54 recognizes that the content of the header such as History-Info in the SIP signal 41a is unnatural and a warning is necessary.

The call processing unit 53 creates the call signal 40a obtained by extracting a call receiving number “0422-88-8888” described in INVITE of the received SIP signal 41a. Then, the call transmission unit 55 sends a guidance for warning before the call of the call signal 40a is started to the receiving side terminal 31.

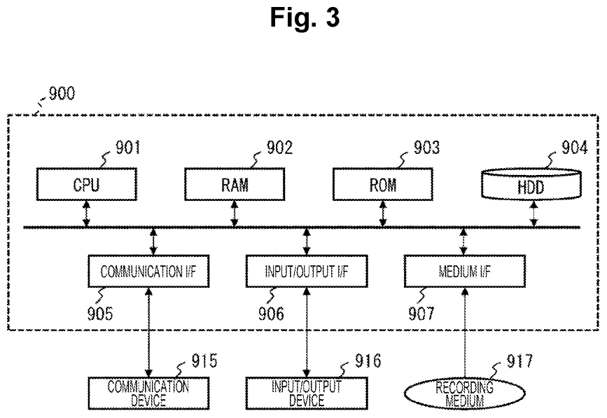

FIG. 3 is a hardware configuration diagram.

The SIP server 20 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Moreover, the CPU 901 controls each processing unit by executing a program (also referred to as an application or an app for abbreviation thereof) read into the RAM 902. Then, the program can be distributed via a communication line or recorded in a recording medium 917 such as a CD-ROM and distributed.

FIG. 4 is a flowchart illustrating details of warning necessity determination processing executed by the SIP server 20. In this flowchart, in a case where the number conversion history meets a specific condition, the SIP server 21 determines that a warning is necessary.

The SIP server 21 acquires the number conversion history from the received SIP signal and calculates parameters i, j, and k to be used in an evaluation expression of a warning (S101). The larger the numerical values of these parameters i, j, and k are, the more suspicious they are as the caller of the special fraud, and consequently, guidance for warning before the start of a call of the call signal 40a is also more likely to be sent to the receiving side terminal 31.
The parameter i is the number of times of transfer. For example, three telephone numbers 050-1111-2222@23D, 03-1111-3333@22D, and 0422-88-8888@21D are described in the History-Info header of the SIP signal 41a in FIG. 1, and when 0422-88-8888@21D of receiving side terminal 31 is excluded, i=2.
The parameter j is the number of passed service providers. For example, three service provider IDs of “@21D, @22D, and @23D” are described in the History-Info header of the SIP signal 41a in FIG. 1, and when the receiving side service provider 21D is excluded, j=2. As described above, from the combination of the calling number type and the service provider domain, the SIP server 20 can specify the number of service providers through which each received signal has passed. Note that, in general, since one or more transfers are performed within a range of a certain service provider (for example, within the same government office), i≥j>0 holds.
The parameter k is a calling number setting. For example, when setting a calling number of the SIP signal 41a in FIG. 1=notification, k=1 is set, and when the calling number setting=non-notification, k=2 is set.

The SIP server 21 determines whether or not the SIP signal 41a in FIG. 1 is a call from a foreign country (S102). For example, in a case where the SIP signal 41a includes an international call identifier, it is a call from a foreign country (S102, Yes), and thus the process proceeds to S103, and if No in S102, the process proceeds to S104.

The SIP server 21 determines whether or not a determination expression “j≥Th1” (Th1 is a first threshold serving as a reference value for a case of a foreign call) is satisfied (S103). If Yes in S103, the SIP server 21 determines that a warning is necessary before calling the receiving side terminal 31 (S112), and if No in S103, the SIP server 21 determines that a warning is unnecessary (S111).

The SIP server 21 calculates a warning score p=i×j×k in a case of a domestic call (S104). The larger the warning score, the more suspicious it is as the caller of the special fraud.

The SIP server 21 determines whether or not a determination expression “p≥Th2” (Th2 is a second threshold that is a reference value for domestic call) in a case of a domestic call is satisfied (S105). If Yes in S105, the SIP server 21 determines that a warning is necessary before calling the receiving side terminal 31 (S112), and if No in S105, the SIP server 21 determines that a warning is unnecessary (S111).

In FIG. 4 described above, different determination expressions are used for a case of a foreign call and a case of a domestic call. On the other hand, the SIP server 21 may calculate the following parameters m and n.
The parameter m (first variable) indicates a transmission source opposition. The weighting is set higher in a case of a foreign call (m=2) than in a case of a domestic call (m=1).
The parameter n (second variable) indicates an evaluation value corresponding to the calling number type (0AJ/0A0, service provider domain). For example, a low weighting is set in advance for 0AJ/0A0 in the reliable region or the reliable service provider domain.
The parameter k (third variable) is the calling number setting as described above.

Then, the SIP server 21 calculates a warning score p2=(α×m)+(β×n)+(γ×k) (instead of S104), and determines whether or not the determination expression “p2≥Th3” (third threshold) is satisfied (instead of S105). Here, by setting the weight α>β>γ, it is assumed that the transmission source opposition of the calling side information of the calling side terminal 11 is prioritized, the calling number type is prioritized next, and the calling number setting is not prioritized over them.

In addition, the SIP server 21 may combine the determination processing illustrated in FIG. 4 with at least one of other determination processing 1 and 2 exemplified below to finally determine the necessity of warning.

(Determination processing 1) A method of warning of a call from a calling number listed in a black list by collating the calling number of the call with a black list registered in advance as described in Patent Literature 2.

(Determination processing 2) A method of warning of a keyword extracted from call content by voice recognition is collated with problem words registered in a database in advance, so that a call that has uttered a problem word is warned through another route (by e-mail or the like to a subscriber or a relative). Note that, like a spam mail filter, a combination of the problem word spoken on the phone and the determination result of the special fraud may be used as correct answer data, and the content of the database may be learned by the analysis AI (Artificial Intelligence) of the special fraud.

For example, the SIP server 21 determines that a warning is necessary in a case where any one of the determination processing in FIG. 4 and the following determination processing is satisfied.

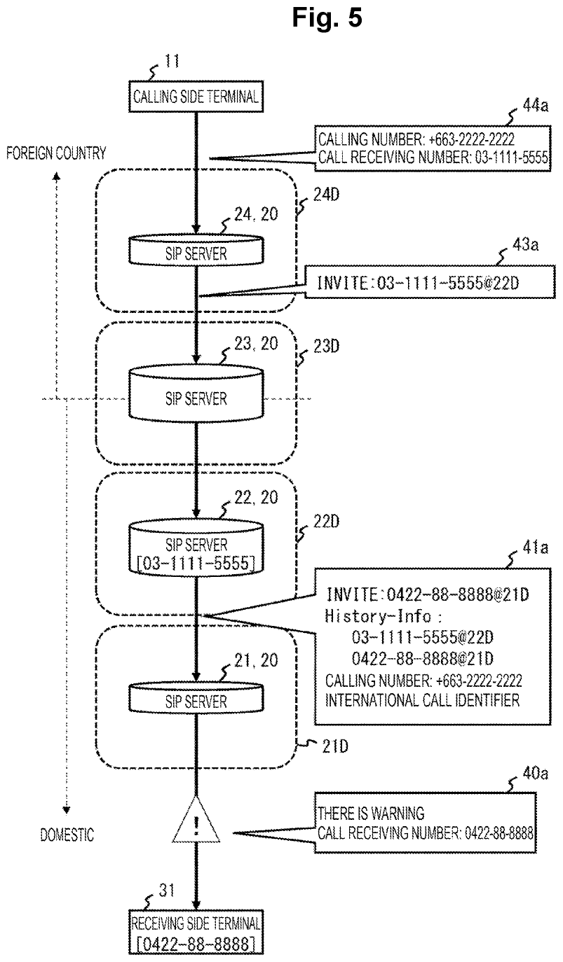

Hereinafter, specific cases in which the determination processing of FIG. 4 is used will be described with reference to FIGS. 5 to 7.

FIG. 5 is a configuration diagram in a case where a call is made through a foreign service provider. Although the system configuration is roughly common between FIG. 1 and FIG. 5, there are differences as follows.
Since the calling side terminal 11 is located on the foreign side, the calling number in FIG. 5 is replaced with a foreign number (+663-2222-2222).
The connection service provider 23D in FIG. 5 manages the SIP server 23 that relays a call across two countries. Since the SIP server 23 merely relays without transferring, no transfer number is assigned to the SIP server 23.
The transfer number [03-1111-3333] of the SIP server 22 is replaced with [03-1111-5555].

In a case of relaying a call across two countries, the SIP server 23 sets an international call identifier in the received SIP signal 43a and then relays the received SIP signal 43a to the SIP server 22. The international call identifier is set, for example, as “verstat=No-TN-Validation” in a P-Asserted-Identity header (hereinafter referred to as a PAID header) indicating calling number information of the SIP signal 43a.

Since the international call identifier is information distributed between the service providers of the connection service provider 23D and the connection service provider 22D, the international call identifier is not affected even if information (calling number) outside the service provider is frequently changed.

Note that the “verstat=No-TN-Validation” is an identifier indicating that the calling number is not validated. This identifier is specified to be assigned to the calling number given by a foreign telecommunications carrier in the standardization document JJ-90.30 (common interconnection interface between IMS business networks) of the Association of General Corporate Members Information Communication Technology (The Telecommunication Technology Committee).

That is, when relaying a call across two countries, the SIP server 23 of the connection service provider 23D is required to give “verstat=No-TN-Validation”.

Since the calling number is a foreign number (+663-2222-2222), the international call identifier is included in the History-Info header of the SIP signal 41a received by the SIP server 21. Accordingly, the SIP server 21 satisfies the determination expression “j≥Th1” (Th1=1) in a case of a foreign call (S103, Yes), and thus it is determined that a warning is necessary (S112).

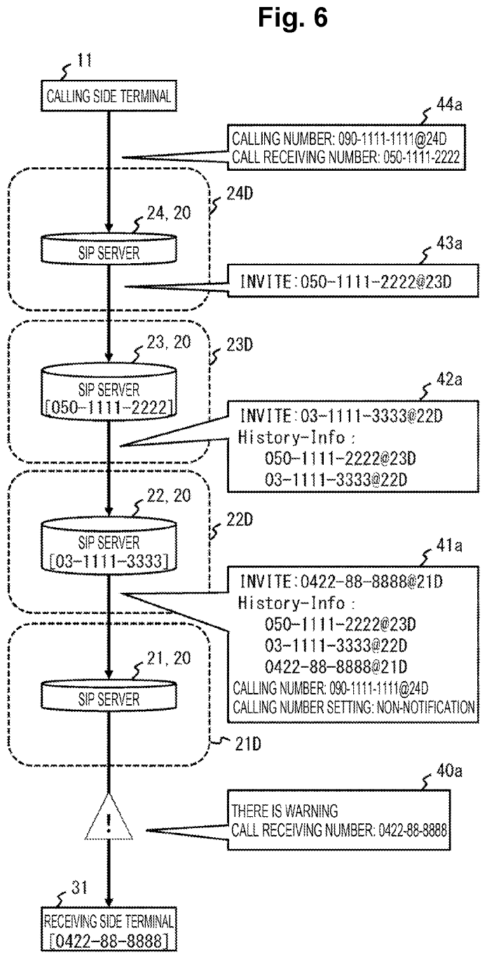

FIG. 6 is a configuration diagram in a case where a call is made through a plurality of service providers. The system configuration is roughly common between FIGS. 1 and 6. On the other hand, in FIG. 6, there is a difference that a call is made with non-notification calling number setting from the calling side terminal 11 by inputting “184” or the like indicating non-notification prior to the call receiving number.

Therefore, the History-Info header of the SIP signal 41a received by the SIP server 21 includes “calling number setting: non-notification”. Accordingly, the SIP server 21 calculates the parameters i, j, and k from the received SIP signal as follows (S101).
The parameter i (the number of times of transfer) is i=2, which is the same as in FIG. 1.
The parameter j (the number of passed service providers) is also j=2, which is the same as in FIG. 1.
The parameter k (calling number setting) is non-notification k=2, unlike FIG. 1.

Then, the SIP server 21 calculates a warning score p=i×j×k=8 in a case of a domestic call (S104). Since the SIP server 21 satisfies the determination expression “p≥Th2” (Th2=5) in a case of a domestic call (S105, Yes), it determines that a warning is necessary (S112).

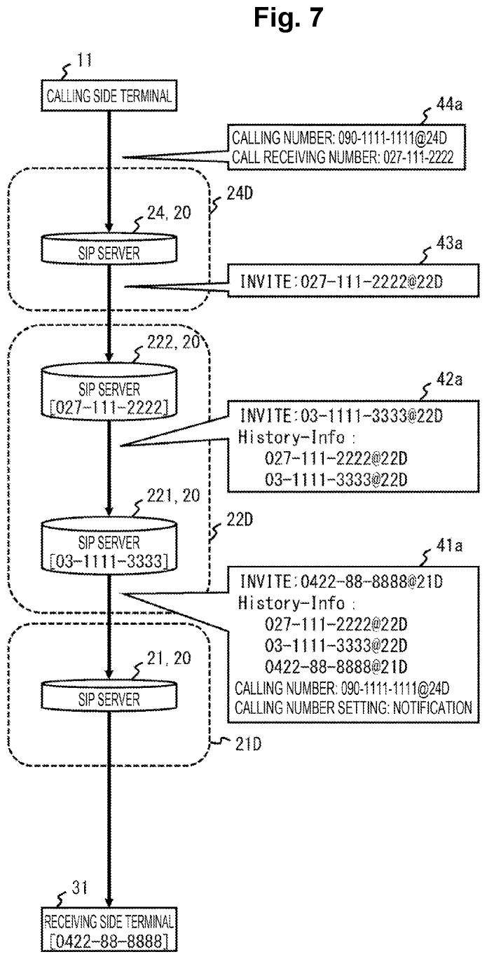

FIG. 7 is a configuration diagram in a case where an excessive warning is suppressed. The system configuration is roughly common between FIG. 6 and FIG. 7, but there are the following differences.
A call is made from the calling side terminal 11 in FIG. 7 by the calling number setting of notification. Thus, the History-Info header of the SIP signal 41a received by the SIP server 21 includes “calling number setting: notification”.
In FIG. 7, the number of connection service providers is reduced by one. That is, the SIP server 23 accommodated in the connection service provider 23D in FIG. 6 is the SIP server 222 accommodated in the connection service provider 22D in FIG. 7. Similarly, the SIP server 22 accommodated in the connection service provider 22D in FIG. 6 is the SIP server 221 accommodated in the connection service provider 22D in FIG. 7.

The SIP server 21 calculates the parameters i, j, and k from the received SIP signal 41a as follows (S101).
The parameter i (the number of times of transfer) is i=2, which is the same as in FIG. 6.
The parameter j (the number of passed service providers) is reduced by one from that in FIG. 6 to j=1.
The parameter k (calling number setting) is set to k=1 of the notification, unlike FIG. 6.

Then, the SIP server 21 calculates a warning score p=i×j×k=2 in a case of a domestic call (S104). The SIP server 21 does not satisfy the determination expression “p≥Th2” (Th2=5) in a case of a domestic call (S105, No), and thus determines that the warning is unnecessary (S111).

As described above, as compared with the comparative example in which the necessity of the warning is determined only by the number i of times of transfer, in the present embodiment that comprehensively refers to the “the number i of times of transfer, the number of passed service providers j, and the calling number setting k”, it is possible to rescue a normal call and suppress an excessive warning even if the number i of times of transfer is large.

### [Effects]

The SIP server 21 of the present invention includes:
an SIP reception unit 52 that receives a call signal originated in a calling side terminal 11 for a receiving side terminal 31 as a transmission destination;
an SIP processing unit 54 that determines that a warning signal is necessary in a case where a combination of a number conversion history of the call signal set by a connection service provider 22D that has transferred the call signal by a transfer service involving number conversion and calling side information of the calling side terminal 11 set in the call signal meets a specific condition; and
a call processing unit 53 that transmits the warning signal to the receiving side terminal 31 before transmitting the call signal to the receiving side terminal 31 according to the determination of the SIP processing unit 54.

Thus, even if the specific information (such as the calling number) of the caller of the special fraud is hidden along with the transfer of the call signal, it is possible to appropriately issue a warning with respect to a suspicious call signal from the transfer situation.

In the present invention, as the specific condition, the SIP processing unit 54
determines, in a case where the calling side terminal 11 is in a foreign country for the receiving side terminal 31, that the warning signal is necessary when the number of passed service providers of the call signal read from the number conversion history is equal to or more than a first threshold, and
determines, in a case where the calling side terminal 11 is domestic for the receiving side terminal 31, that the warning signal is necessary when a result of an evaluation expression based on a number of times of transfer of the call signal read from the number conversion history, the number of passed service providers of the call signal read from the number conversion history, and a calling number setting of the call signal is equal to or more than a second threshold.

Accordingly, when the calling side terminal 11 is in a foreign country, the necessity of the warning signal is determined without referring to the number of times of transfer of the call signal. Thus, it is possible to frequently warn of a call signal having a high possibility of special fraud in which the calling side terminal 11 is in a foreign country.

Furthermore, since a comprehensive evaluation is performed with not only the number of times of transfer but also other indexes for a call signal of which the calling side terminal 11 is domestic, it is possible to rescue a normal call and suppress an excessive warning even if the number of times of transfer is large.

In the present invention, as the specific condition, the SIP processing unit 54
determines, with respect to a first variable indicating whether the calling side terminal 11 is in a foreign country or domestic for the receiving side terminal 31, a second variable indicating a calling number type of the call signal, and a third variable indicating a calling number setting of the call signal, that the warning signal is necessary when a result of an evaluation expression including the first variable, the second variable, and the third variable in descending order of priority is equal to or more than a third threshold.

Thus, it is possible to determine the necessity of the warning signal with emphasis on the calling side information of the calling side terminal 11.

The present invention is characterized in that, in addition to a case where the specific condition is met, the SIP processing unit 54 determines that the warning signal is necessary when the calling number of a call is a calling number listed in a black list registered in advance.

Accordingly, it is possible to appropriately issue a warning even with respect to a call signal whose calling number is suspicious.

The present invention is characterized in that, in addition to a case where the specific condition is met, the SIP processing unit 54 determines that the warning signal is necessary when a keyword extracted from call content of the call signal by voice recognition matches a problem word registered in a database in advance.

Accordingly, it is possible to appropriately issue a warning even with respect to a call signal whose call content is suspicious.

### REFERENCE SIGNS LIST

11 Calling side terminal
20 SIP server
21 SIP server (call warning device)
22 SIP server (connection device)
23 SIP server (connection device)
24 SIP server
21D Receiving side service provider
22D Connection service provider
23D Connection service provider
24D Calling side service provider
31 Receiving side terminal
40 Call signal
41 SIP signal
42 SIP signal
43 SIP signal
44 Call signal
51 Call reception unit
52 SIP reception unit (call signal reception unit)
53 Call processing unit (warning processing unit)
54 SIP processing unit (call signal processing unit)
55 Call transmission unit
56 SIP transmission unit

1. A call warning device, comprising:
a call signal reception unit, including one or more processors, configured to receive a call signal originated in a calling side terminal for a receiving side terminal as a transmission destination;
a call signal processing unit, including one or more processors, configured to determine a warning signal is necessary in a case where a combination of a number conversion history of the call signal set by a connection device that has transferred the call signal by a transfer service involving number conversion and calling side information of the calling side terminal set in the call signal meets a specific condition; and
a warning processing unit, including one or more processors, configured to transmit the warning signal to the receiving side terminal before transmitting the call signal to the receiving side terminal according to the determination of the call signal processing unit.

2. The call warning device according to claim 1, wherein
as the specific condition, the call signal processing unit is configured to:
determine, in a case where the calling side terminal is in a foreign country for the receiving side terminal, that the warning signal is necessary when a number of passed service providers of the call signal read from the number conversion history is equal to or more than a first threshold, and
determine, in a case where the calling side terminal is domestic for the receiving side terminal, that the warning signal is necessary when a result of an evaluation expression based on a number of times of transfer of the call signal read from the number conversion history, the number of passed service providers of the call signal read from the number conversion history, and a calling number setting of the call signal is equal to or more than a second threshold.

3. The call warning device according to claim 1, wherein
as the specific condition, the call signal processing unit is configured to determine, with respect to a first variable indicating whether the calling side terminal is in a foreign country or domestic for the receiving side terminal, a second variable indicating a calling number type of the call signal, and a third variable indicating a calling number setting of the call signal, that the warning signal is necessary when a result of an evaluation expression including the first variable, the second variable, and the third variable in descending order of priority is equal to or more than a third threshold.

4. The call warning device according to claim 3, wherein
in addition to a case where the specific condition is met, the call signal processing unit is configured to determine that the warning signal is necessary when the calling number of a call is a calling number listed in a black list registered in advance.

5. The call warning device according to claim 1, wherein
in addition to a case where the specific condition is met, the call signal processing unit is configured to determine that the warning signal is necessary when a keyword extracted from call content of the call signal by voice recognition matches a problem word registered in a database in advance.

6. A call warning method wherein a call warning device includes a call signal reception unit, a call signal processing unit, and a warning processing unit, the call warning method comprising:
receiving, by the call signal receiving unit, a call signal originated in a calling side terminal for a receiving side terminal as a transmission destination;
determining, by the call signal processing unit, that a warning signal is necessary in a case where a combination of a number conversion history of the call signal set by a connection device that has transferred the call signal by a transfer service involving number conversion and calling side information of the calling side terminal set in the call signal meets a specific condition; and
transmitting, by the warning processing unit, the warning signal to the receiving side terminal before transmitting the call signal to the receiving side terminal according to the determination of the call signal processing unit.

7. A call warning program for causing a computer to function as the call warning device according to claim 1.
